(19) United States
(12) Patent Application Publication
(10) Pub. No.: US 2009/0153435 A1
(43) Pub. Date: Jun. 18, 2009

(54) Presentation System

(75) Inventor: David Butler, Stowmarket (GB)

Correspondence Address: NIXON & VANDERHYE, PC, 901 NORTH GLEBE ROAD, 11TH FLOOR, ARLINGTON, VA, 22203, US

(73) Assignee: BRITISH TELECOMMUNICATIONS PUBLIC LIMITED COMPANY, Greater London (GB)

(21) Appl. No.: 11/992,222

(22) PCT Filed: Sep. 7, 2006
(86) PCT No.: PCT/GB2006/003313

§ 371 Date: Mar. 19, 2008

(30) Foreign Application Priority Data
Sep. 29, 2005 (GB) 0519855.1

(51) Int. Cl. G09G 5/00

(52) U.S. Cl. 345/1.3

(57) ABSTRACT

A presentation system comprises a personal computer (PC) (1) and a display arrangement (3). The display arrangement (3) includes a large main monitor (5) and four small satellite monitors (7a-7d) arranged around the main monitor. Each monitor (5, 7a-7d) is a thin-film transistor liquid crystal display (TFT-LCD) and is separately connected to the PC (1) by a respective cable and video driver (not shown). An operating system is stored on the PC (1), as are two application programs, referred to herein as the interactive process visualisation (IPV) program and the multi-monitor support (MMS) program. The IPV program is an application which enables the user to show a presentation in the main monitor (5). This presentation can include a range of media, such as images, animations, video streams and so on. In addition, the IPV program is arranged to run an executable command which invokes one or more instantiations of the MMS program. The purpose of the MMS program is to enable convenient control over what is displayed on a selected one of the satellite monitors (7a-7d). Thus, the command in the IPV program can be used to invoke up to four separate instantiations of the MMS program to control what is displayed on up to four satellite monitors (7a-7d). By incorporating suitable commands at different sections of the main IPV presentation, for example when a particular slide is shown, it is possible to synchronise content displayed on the main monitor (5) with other (e.g. related) content displayed on the satellite monitors (7a-7d).

### FIELD OF THE INVENTION

The present invention relates to a presentation system, particularly a computer-based presentation system employing a plurality of display devices e.g. monitors. The invention also relates to a method of controlling a presentation system.

### BACKGROUND TO THE INVENTION

Presentations are a common practice in many organisations, for example in marketing, industrial and educational organisations. In contrast to traditional presentation methods, which typically involve flip-charts or over-head projectors, it is now common for presentations to be prepared and performed using computer systems. For example, the well-known Microsoft Powerpoint® software can be used to prepare a virtual slideshow wherein the slides include text, images and animation. The slideshow can be presented on a computer monitor or using a digital projection system.

The person preparing such a presentation is often restricted in terms of the amount and type of information that can displayed at a given time. There is only so much information that a slide can contain without the information becoming unreadable. Therefore, related information is often spread out over a number of slides. It is also difficult to incorporate other forms of media, such as video from a webcam or an internet webpage, into the presentation. This ordinarily requires the presenter to minimise the slideshow application and open a separate application, e.g. a browser, to display the webpage. The effectiveness of a presentation can be limited by these disadvantages.

It is desirable to provide a presentation system which is flexible in terms of the information that can be displayed.

### SUMMARY OF THE INVENTION

According to a first aspect of the invention, there is provided a method of presenting content on a presentation system comprising multiple display devices, the method comprising: providing first media content for display on a first display device; and associating an executable command with the first media content or part thereof; wherein the executable command is operable to cause output of second media content on a further display device, the command being executed in response to the first media content being output on the first display device or a user action initiated during said output.

The first media content may be an image forming part of a slideshow presentation comprising a plurality of images.

The first media content may be an image and the method can further comprise associating the executable command with a sub-region of the image such that the command is executed in response to a user action initiated with respect to said sub-region. For example, the command can be executed In response to a user positioning a pointer or cursor over said sub-region. Alternatively, the command can be executed after a particular key or button is pressed or after a predetermined amount of time from when a particular piece of content, such as a slide or the end of a movie clip, is shown.

The executable command may specify an address or link from where the second media content is retrievable.

The executable command may further specify an address or label identifying the further display device onto which the second media content is to be output. The executable command may further specify formatting parameters which are to be applied to the second media content when it is output.

The executable command can comprise a first part identifying an executable application and a second part specifying (i) an address or link from where the second media content is retrievable and (ii) one or both of a display device and/or at least one formatting parameter, the executable application being arranged to output the second media content in accordance with information specified in the second part.

The method may further comprise the step of constructing the executable command by means of presenting a dialogue box indicating a one or more options for inclusion in the command and storing the command once said one or more options are selected by a user. In this way, a convenient and intuitive method of constructing the executable command is possible.

According to a second aspect of the invention, there is provided a method of controlling a computer presentation system employing a main display device and one or more auxiliary display devices, the method comprising: generating a first presentation for display on the main display device, the first presentation including first displayable content; and generating one or more auxiliary presentations for display on a respective one of the auxiliary display devices; wherein the step of generating the first presentation includes associating the displayable content or part thereof with an auxiliary presentation which is thereafter displayable on one of the auxiliary display devices when said presentation content is displayed on the main display device.

According to a further aspect of the invention, there is provided a presentation system comprising: a control system; a first display device connected to the control system; and one or more further display devices connected to the control system; wherein the control system is operable to (a) display first media content on the main display device, (b) associate an executable command with the first media content or part thereof, (c) in response to the first media content being displayed or a user action initiated during said display, causing execution of the executable command to cause output of second media content on one of the further display devices.

The description also describes a method of controlling a computer presentation system employing a plurality of display devices, the method comprising: (a) generating a display area and dividing said display area into a plurality of sub-areas; (b) assigning each of the sub-areas to a respective one of the display devices; (c) receiving a user command and identifying therefrom (i) content data to be displayed and (ii) data indicative of one of said display devices; and (d) displaying the identified content data on the display sub-area assigned to the identified display device.

The content data may be a stored data file and the user command can indicate its storage location, step (c) including identifying the storage location of said data file and retrieving it for display in step (d). The user command can include formatting information specifying at least one formatting process to be applied to the content data, step (c) including identifying and applying said at least one formatting process to the content data. The stored data file may be any one of an image file, a movie file, a chart file or a slide show file.

The content data can be downloadable over a network link and the user command includes the network location of said content data, step (c) including downloading said content data from the network location for display in step (d). The content data can be an Internet web-page and the user command includes its URL location, step (d) including launching a web-page browser and displaying the web-page therein.

There is also described a method of controlling a computer presentation system employing first and second display devices, the method comprising: (a) generating a display area and associating first and second sub-regions of said display area with the first and second display devices; (b) receiving a user command Indicating (i) first and second sets of content data and (ii) data Indicative of the display devices on which said first and second sets of content data are to be respectively displayed; and (c) displaying said first and second sets of content data using the display sub-region associated with the display device indicated in the user command.

There is also described a method of controlling a computer presentation system employing a main display device and one or more auxiliary display devices, the method comprising: generating a first presentation for display on the main display device, the first presentation including first displayable content; and generating one or more auxiliary presentations for display on a respective one of the auxiliary display devices; wherein the step of generating the first presentation includes associating the displayable content with an auxiliary presentation which is thereafter displayable on one of the auxiliary display devices when said presentation content is displayed on the main display device.

There is also described a presentation system comprising: a control system; and a plurality of display devices connected to the control system, wherein the control system is arranged to: (a) generate a display area and divide said display area into a plurality of sub-areas; (b) assign each of the sub-areas to a respective one of the display devices; (c) receive a user command and identify therefrom (i) content data to be displayed and (ii) a display device onto which said content data is to be displayed; and (d) display the identified content data on the display sub-area assigned to the identified display device.

There is also described a presentation system comprising: a control system; a main display device connected to the control system; and a plurality of auxiliary display devices connected to the control system; wherein the control system is operable to (a) display a first presentation on the main display device, (b) receive a command indicating at least one set of content data and an auxiliary display device on which to display said content data, and (c) display said at least one set of content data on said auxiliary display device.

### BRIEF DESCRIPTION OF THE DRAWINGS

The invention will now be described, by way of example, with reference to the accompanying drawings in which:

FIG. 1 is a schematic diagram of a presentation system comprising a personal computer (PC) and display arrangement;

FIG. 2 is a block diagram showing the main hardware components of the PC;

FIGS. 3a-3c are screen shots which are useful for understanding the step of configuring the PC to display content on multiple monitors.

FIG. 4 is a block diagram representing the logical relationship of first and second presentation programs running on the PC;

FIG. 5 is a flow diagram showing the main steps performed by the second presentation program;

FIGS. 6a-6c are block diagrams representing the interrelationship between parameters which are decoded by the second application program; and

FIG. 7 is a screen shot of a scripter interface that enables user-friendly input of parameters for the second application program.

### DETAILED DESCRIPTION OF A PREFERRED EMBODIMENT

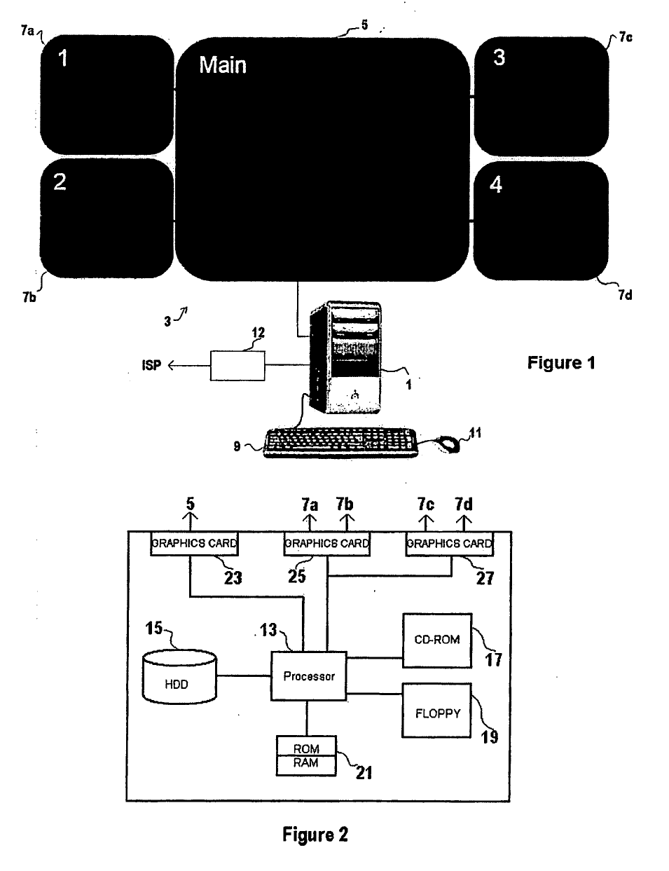

Referring to FIG. 1, a presentation system comprises a personal computer (PC) 1 and a display arrangement 3. The display arrangement 3 includes a large main monitor 5 and four smaller satellite monitors 7a-7d arranged around the main monitor. Each monitor 5, 7a-7d is a thin-film transistor liquid crystal display TFT-LCD and is separately connected to the PC 1 by a respective cable and video driver (not shown). Input devices in the form of a keyboard 9 and mouse 11 are also connected to the PC 1 using standard USB connectors. The PC 1 is connected to the Internet by means of a broadband router 12 which provides a connection between the PC and the user's internet service provider (ISP).

Referring to FIG. 2, the main hardware elements of the PC 1 are shown. The PC 1 is based on a standard desktop computer and a person skilled in the art will appreciate that a number of components will be present including a microprocessor 13, a hard disk drive 15, a CD-ROM drive 17, a floppy disk drive 19 and ROM/RAM 21. The main monitor 5 is connected to the PC 1 via a first graphics card 23 provided as a standard component of the PC. The satellite monitors 7a-7d are connected to the PC 1 via first and second peripheral component interconnect (PCI) graphics cards 25, 27 each of which runs two monitors via the PCI bus of the PC. Suitable PCI graphics cards are available from a number of manufacturers, including ATi and Nvidia. In the present case, two ATi Radeon graphics cards are employed.

Although not shown in FIG. 2, the PC 1 also includes respective USB ports to enable connection of the keyboard and mouse peripherals 9, 11 to the PC. An Ethernet port is also provided to enable connection of the router 12 using a suitable cable.

An operating system, namely the Microsoft Windows XP® operating system (hereafter simply ‘XP’) is stored on the hard disk drive 15. Also stored on the hard disk drive 15 are two application programs, referred to herein as the interactive process visualisation (IPV) program and the multi-monitor support (MMS) program. The operation of both programs will be explained in detail below. The IPV and MMS programs can initially be supplied on portable storage media such as a floppy disk or CD-ROM, in which case they are transferred to the hard disk drive 15 for subsequent installation and operation. Alternatively, the programs can be made available from a remote computer and downloaded to the PC 1 over a network link, e.g. the Internet link indicated in FIG. 1.

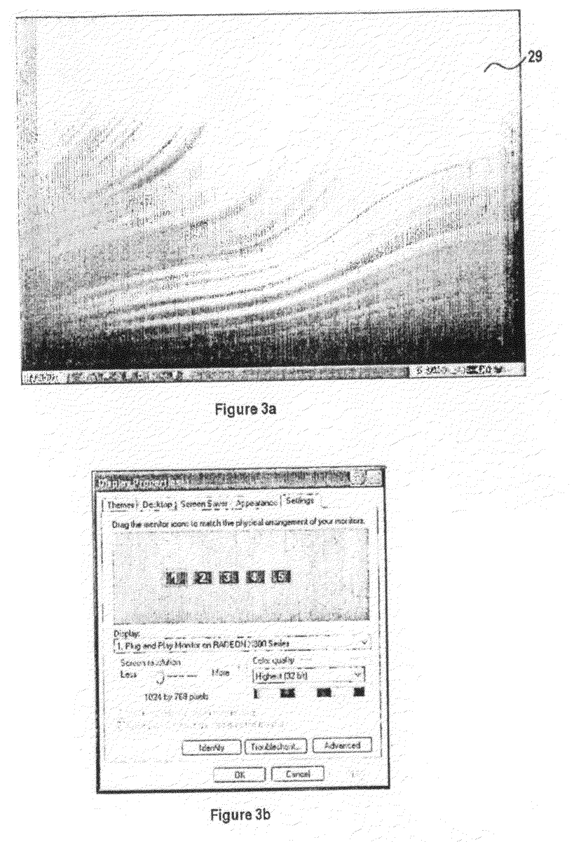

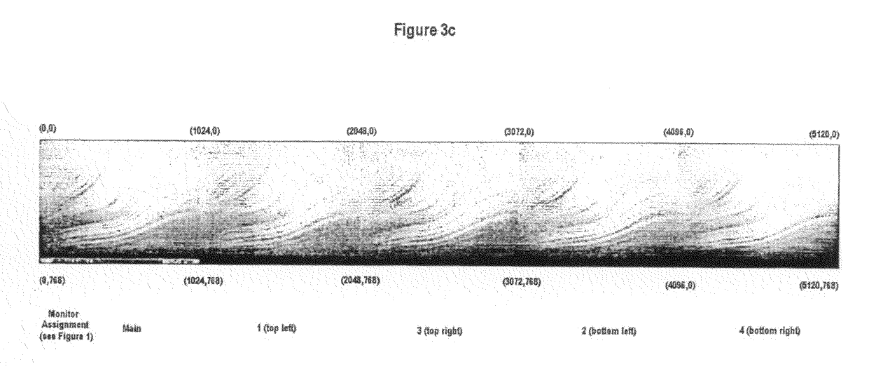

The main monitor 5 and the four satellite monitors 7a-7d are configured so that they each display a sub-region of the XP desktop. This configuration is relatively straightforward and uses the “Multiple Monitors” feature standard to XP. Other operating systems offer a similar feature. To explain the configuration step, reference is made to FIG. 3a which shows the XP desktop 29 as one would normally expect to see on a standard single-monitor system. After connecting the satellite monitors 7a-7d to the PC 1, XP automatically detects the presence of multiple graphics cards when the PC is next switched on. Referring to FIG. 3b, configuration of the monitors is achieved by accessing the ‘Display Properties’ menu of the XP control panel and selecting the ‘Settings’ tab. The main monitor is represented on the Settings panel by the numeral ‘1’ and the satellite monitors 7a-7d by the numerals 2 to 5. By selecting each of the monitor representations in turn and clicking the button for ‘Extend my Windows desktop onto this monitor’ the XP desktop 29 is extended so as to be displayed on each of the five monitors 5, 7a-7d. As indicated in FIG. 3c, a larger desktop is created with each of the monitors 5, 7a-7d being assigned a respective one-fifth portion. This assignment can be altered using a simple drag-and-drop operation within the settings menu. In this way, the user assigns each monitor 5, 7a-7d a set of unique desktop co-ordinates to display, which co-ordinate assignments are stored on the hard disk drive 15. In this embodiment, the resolution of the extended desktop is set to 5120 by 768 pixels in the Settings panel and so each monitor displays a respective 1024 by 768 portion. The co-ordinates assigned to each monitor are indicated in FIG. 3c.

The above-mentioned IPV program is an application which enables the user to show a presentation. In this embodiment, the IPV application allows the user to prepare a main presentation for display on the main monitor 5. Accordingly, video data output by the IPV application is displayed using the desktop co-ordinates assigned to the main monitor 5. The IPV presentation can include a range of media, such as images, animations, video streams, slideshows and so on. In addition, the IPV program is arranged to run a script line which invokes one or more instantiations of the MMS program. The purpose of the MMS program is to enable convenient control over what is displayed on a selected one of the satellite monitors 7a-7d. Thus, the script line in the IPV program can be used to invoke up to four separate instantiations of the MMS program to control what is displayed on up to four satellite monitors 7a-7d. By embedding suitable script lines at different sections of the main IPV presentation, it is possible to synchronise content displayed on the main monitor 5 with other (e.g. related) content displayed on the satellite monitors 7a-7d, for example when a particular slide is displayed. Alternatively, or additionally, the MMS script line can be invoked in response to a user command during the IPV presentation, e.g. if the user passes the mouse pointer over a particular region or clicks on a link displayed on the main monitor 5. Alternatively still, a particular piece of content might be displayed on a satellite monitor after a predetermined amount of time has passed following display of a particular piece of content.

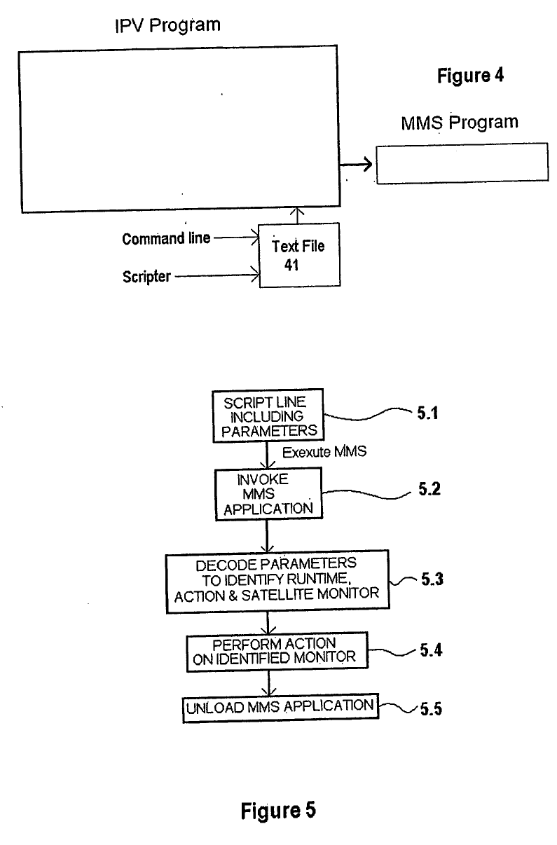

FIG. 4 represents the logical arrangement of the IPV and MMS programs. One or more MMS script lines can be embedded in the IPV program by the user. The user will specify some action within the main presentation which causes the MMS script line to be invoked, e.g. when slide ‘x’ is revealed. Script lines are stored in a dedicated text file 41, either by typing the script line in the XP command line dialogue box or by using a so-called scripter utility. Both methods will be described below. When the IPV presentation is subsequently run, the appropriate MMS script line is sent to the MMS application when the relevant action takes place, following which it is decoded by the MMS application to display content on one of the satellite monitors 7a-7d. The MMS program can be run from any application capable of running external applications. The MMS program can also be run direct from the PC command line or via a network connection.

The script line includes a number of parameters which determine the content to be displayed, and on which monitor said content is to be displayed. In this embodiment, the user can also specify how long the content is displayed. When executed, the script line causes an instantiation of the MMS program to be run and the parameters are decoded according to their respective order in the script line. This will be explained in more detail below. By providing the MMS program facility, the display of content on the satellite monitors is significantly simplified and the user does not have to manually drag content over the virtual desktop until it appears in the appropriate satellite monitor 7a-7d. Rather, the MMS program automatically handles the retrieval of content from an Identified location and the display of said content on the appropriate part of the desktop using the co-ordinate information stored on the hard disk drive 15.

An overview of the MMS program, when executed, is represented in FIG. 5. In a first stage 5.1, the script line (which includes the above-mentioned parameters) is passed to the MMS program. The parameters specify what action is to be performed and on which monitor. The content to be displayed will also be specified in the script line. The format of the script line is as follows:

“<location of MMS program>” <parameters P₁-Pₙ>

In the next two steps 5.2, 5.3, the MMS program is executed from its identified location and the parameters decoded to identify the above-mentioned action and monitor information. The content to be displayed is included in the parameter information. In this embodiment, the parameters also indicate the duration over which the content should be displayed, either in terms of a specified time period (e.g. fifteen seconds) or, in the case of certain types of video content, the number of video loops. This information can be set so that content is displayed indefinitely as may be appropriate for certain types of content. In the next step 5.4, the action specified in the script line is performed and the specified content displayed in the appropriate satellite monitor. In the final step 5.5, the MMS program is closed. This will occur at the end of the specified time period or number of video loops, or, where the time is indefinite, when the user manually closes the program.

In the present implementation of the MMS program, eighteen parameters (P₁-p₁₈) are decoded from the script line. The definition of each parameter is now explained.

P₁ Time until unload. This parameter specifies the number of milliseconds over which the MMS program runs before closing itself down. In the case of certain actions where a number of Image loops is more appropriate, this parameter is ignored.

P₂ Monitor x start position. This parameter is the x-co-ordinate of the top-left pixel for the satellite monitor to be used. So, in the case of the top-left satellite monitor (assigned to the second portion of the desktop) the parameter will be 1024. The assignment of pixels for each satellite monitor can be checked using the Display Settings form in XP.

P₃ Monitor y start position. As for P₂ but using the y-co-ordinate of the top-left pixel.

P₄ Screen size. This parameter has the value 0, 1 or 2. If 1, the screen size is minimised. If 2, the screen size is maximised to cover the entire monitor. If 0, the screen size is user-specified according to parameters P₅ and P₆.

P₅/P₆ Screen width/height in pixels. Only valid if P₄ is 0.

P₇ Screen back colour. A number of available colours are identified by a predetermined number, e.g. black=0, white=16777215, blue#1=16777152 etc. If the action specified in P₈ is to display a web browser, this parameter is ignored.

P₈ Action. For the purposes of the implementation defined herein, this parameter has the value 0, 1, 2 or 3. If 0, an image is displayed in the centre of the screen. If 1, a full screen web browser is displayed, preferably without a title, URL and status bar. If 2, a movie is displayed using Apple Computer Inc.'s QuickTime format. If 3, an image download simulation is run to indicate the relative download speeds of a dial-up and broadband internet connection.

P₉ Image location. If P₈ is set to 0, this parameter indicates the full path to the image to be displayed.

P₁₀ Web browser URL. If P₈ is set to 1, this parameter indicates the URL of the webpage to be downloaded.

P₁₁ Movie Location. If P₈ is set to 2, this parameter indicates the full path to the QuickTime movie.

P₁₂ Movie Scale Factor. If P₈ is set to 2, this parameter determines the scale factor of the movie and has the value of 1 or 2. If 1, the QuickTime window is normal size. If 2, the QuickTime window is double size.

P₁₃ Movie Loop. If P₈ is set to 2, this parameter determines whether the number of times the movie plays before stopping. So, if P₁₃ is set to 2, the movie will play twice before stopping.

P₁₄ Broadband Image Download Simulation Title. If P₈ is set to 3, this parameter indicates the title to be displayed, e.g. “Dial-up 56 k Modem” or “2 Mbit/second Broadband”.

P₁₅ Broadband Image Download Simulation Image. If P₈ is set to 3, this parameter indicates the full path to the image to be used in the simulation.

P₁₆ Broadband Image Download Simulation Speed. If P₈ is set to 3, this parameter specifies the speed at which the image in P₁₅ is revealed in the simulation. The minimum value is 10 and causes the image to be revealed relatively quickly, e.g. to simulate a fast broadband connection. The maximum value is 2000 and causes the image to be revealed relatively slowly, e.g. to simulate a slow dial-up connection.

P₁₇ Broadband Image Download Simulation Reveal Height. If P₈ is set to 3, this parameter specifies the maximum height in pixels at which the image is revealed. This may depend on the actual height of the image.

P₁₈. Broadband Image Download Simulation Picture Loops. If P₈ is set to 3, the value of P₁ is ignored and, instead, this parameter is used to specify the number of loops to be run before the MMS program closes.

It will be appreciated that the above-described parameters (and their associated values) may be varied depending on the intended use of the MMS program. For example, in the case of the action parameter (P₈), an image download simulation is one of the available options due to the applicant using this facility in their current working model. Other actions can be used.

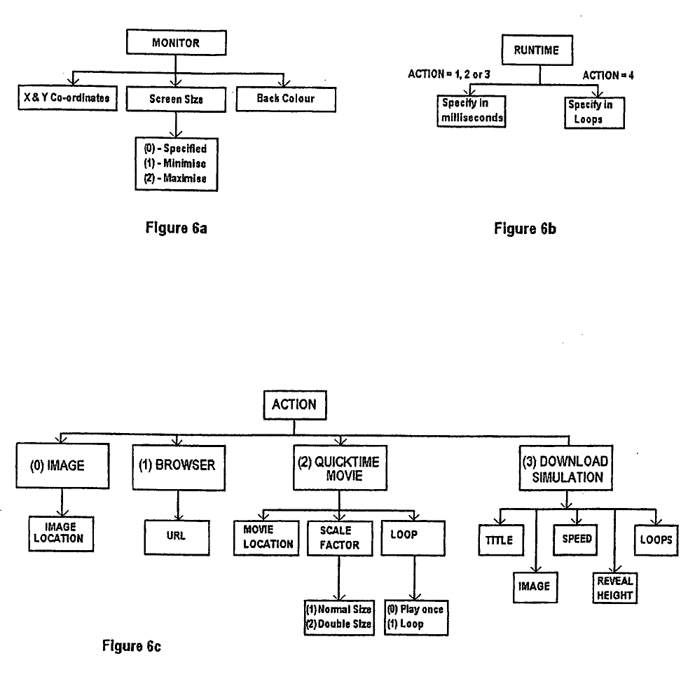

FIGS. 6a-6c indicate the interrelationship between the various parameters which are conveniently grouped into monitor, runtime and action-type parameters. A number of example script lines, and the result of their execution using the MMS program, are given in Appendix A at the end of the description.

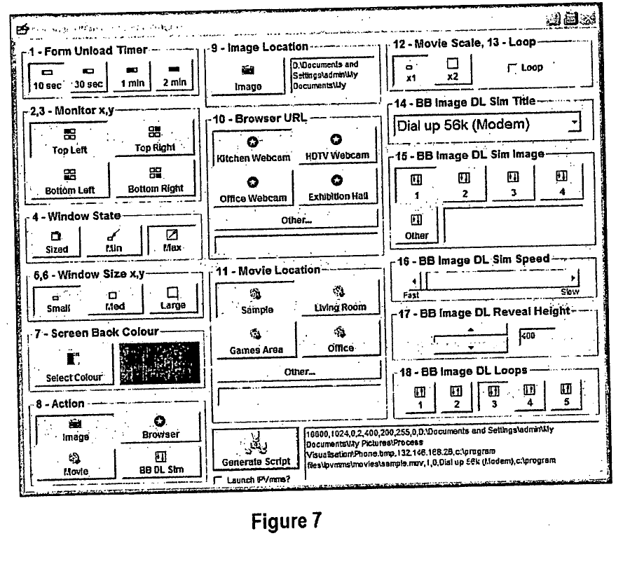

In order to define a script line for the IPV program, the user can type the script line into the command line dialogue box using the Start>Run option in XP. All script lines entered in this way are stored in a dedicated text file 41 (see FIG. 4) which is accessed by the IPV application. As an alternative, the user is provided with an interface facility, referred to herein as an MMS scripter, which enables the user to view representations of the required script parameters and, where appropriate, selectable values for those parameters. FIG. 7 shows an MMS scripter which enables input using the above-mentioned parameter set P₁-P₁₈. It will be seen that a value for P₁ can be selected by clicking one of the option panels. If the “10 sec” panel is selected, the value of parameter P₁ will be set to 10000. It will also be seen that representations for each of the satellite monitors enable the input of values for parameters P₂, P₃. If the top left panel is selected, the respective values of parameters P₂, P₃ will be 1024, 0. The remaining parameters can be specified using similar means. The result is a convenient and simple-to-use interface in which parameters can be set by clicking a panel, browsing for content, using a pull-down menu, and so on. If the availability of certain parameters is dependent on the selection of other parameters, the MMS scripter can automatically disable certain options if they are not relevant. For example, if the user selects ‘Browser’ for P₈, then the selection options for P₇, P₉ and P₁₁ to P₁₈ are automatically disabled whilst the option for P₁₀ remains available. Once all parameter selections have been made and the user is satisfied, the “Generate Scrip” box is selected and the required script line is generated and added to the above-mentioned text file 41 associated with IPV.

The MMS program can be created using Visual Basic Version 5 SP5 and uses an external dynamic link library (DLL) file, e.g. Skylark Lite DLL, to host QuickTime movie playback.

The presentation system can be used to generate and display a presentation which may include one or more content types, e.g. images, slides, video, online web content and so on. To illustrate a practical use of the system, a company operating in the information and communications technology (ICT) sector may wish to demonstrate their current and/or forthcoming activities in a particularly engaging and effective manner. In this case, the main monitor 5 might be used to display a presentation giving an overview of various ICT activities such as broadband, convergent communications systems, advanced billing systems and so on. This presentation can be displayed using the IPV program shown in FIG. 4. Within particular slides of the presentation, links may be provided to other slides so that the presenter can click on a particular activity and then jump to a slide sub-set relevant to that activity. The satellite monitors 7a-7d may be used to enhance the presentation by showing related content. Thus, if the current slide on main monitor 5 relates to broadband access, a first script line can be associated with said slide to invoke the MMS application so that the first satellite monitor 7a displays a bar chart indicating the current and projected take-up of broadband. Parameter P₈ will specify the image action (0) and the path to the bar chart image will be entered as parameter P₉. To demonstrate the company's support infrastructure for broadband, the designer might include a second script line to invoke a second instantiation of MMS so that the second satellite monitor 7b displays an internet browser providing access to the company's online helpdesk/support portal. In this case, the script line will include the browser action (1) as parameter P₈ with the URL of the portal specified as parameter P₁₀. In a similar manner, a third instantiation of MMS might be used to show a broadband marketing video (in Quicktime® format) on the third satellite monitor 7c. Finally, the relative speed advantage of broadband over dial-up access can be conveniently demonstrated using the ‘Broadband Image Download Simulation’ mentioned previously. This is performed using a fourth instantiation of MMS to display the simulation on the fourth satellite monitor 7d.

In the above example, the main slide show is considerably enhanced by simultaneously displaying information relevant thereto without requiring the main slide to be removed, reduced or minimised. Many types of content can be displayed on the satellite monitors, including images, web pages, URL video streams, stored video clips, simulations and so on. The system is versatile and flexible and can be adapted to suit all types of organisation.

### APPENDIX A

### Example MMS Script Lines and Resulting Actions

These script lines assume that the MMS program is called IPVmms.exe and is stored on the PC at C:\Program Files\PVmms\.

### Example 1

### Displaying an Image

“C:\Program Files\IPVmms\IPVmms.exe” 65000,1024,0,2,0,0,255,0, C:\ProgramFiles\pvmms\images\phone.bmp . . .
Runs the IPVmms application for 65000 milliseconds. On the first satellite monitor 7a (co-ordinates 1024,0) the screen is maximized and so the form width and height is irrelevant. Using a background colour of red the specified action is to display an image in the centre of the screen. The image location is c:\program files\ipvmms\images\phone.bmp.

### Example 2

### Displaying a Browser

“C:\Program Files\IPVmms\IPVmms.exe” 65000,3072,0,2,0,0,1, http://www.google.co.uk . . .
Runs the IPVmms application for 65000 milliseconds. On the second satellite monitor 7b (co-ordinates 3072, 0) the screen is maximised and so the form width and height is irrelevant. The background colour is irrelevant as the browser screen is white (zero is input between commas). The specified action is to display a web browser window. Accordingly, no path to an image is required (space is input between commas). Instead, the next parameter indicates the URL to be displayed in the browser, namely http://www.google.co.uk.

### Example 3

### Displaying a Movie

“C:\Program Files\IPVmms\IPVmms.exe” 65000,2048,0,2,0,0,12648447,2, :\ProgramFiles\Ipvmms\movies\sample.mov,1,0 . . .

Runs the IPVmms application for 65000 milliseconds. On the third satellite monitor 7c (co-ordinates 2048,0) the screen is maximised and so the form width and height is irrelevant. Using a background colour of light yellow (indicated by 12648447) the specified action is to display a movie. Accordingly, no image location or URL needs to be specified (spaces between commas). The movie location is identified as C:\Program Files\ipvmms\movies\sample1.mov. The movie scale factor is set to normal size and is played only once (no loop).

1. A method of presenting content on a presentation system comprising multiple display devices, the method comprising:
providing first media content for display on a first display device; and
associating an executable command with the first media content or part thereof;
wherein the executable command is operable to cause output of second media content on a further display device, the command being executed in response to the first media content being output on the first display device or a user action initiated during said output.

2. A method according to claim 1, wherein the first media content is an image forming part of a slideshow presentation comprising a plurality of images.

3. A method according to claim 1, wherein the first media content is an image and the method further comprises associating the executable command with a sub-region of the image such that the command is executed in response to a user action initiated with respect to said sub-region.

4. A method according to claim 3, wherein the command is executed in response to a user positioning a pointer or cursor over said sub-region.

5. A method according to claim 1, wherein the executable command specifies an address or link from where the second media content is retrievable.

6. A method according to claim 5, wherein the executable command further specifies an address or label identifying the further display device onto which the second media content is to be output.

7. A method according to claim 5, wherein the executable command further specifies formatting parameters which are to be applied to the second media content when it is output.

8. A method according to claim 1, wherein the executable command comprises a first part identifying an executable application and a second part specifying (i) an address or link from where the second media content is retrievable and (ii) one or both of a display device and/or at least one formatting parameter, the executable application being arranged to output the second media content in accordance with information specified in the second part.

9. A method according to claim 1, further comprising the step of constructing the executable command by means of presenting a dialogue box indicating a one or more options for inclusion in the command and storing the command once said one or more options are selected by a user.

10. A method of controlling a computer presentation system employing a main display device and one or more auxiliary display devices, the method comprising:
generating a first presentation for display on the main display device, the first presentation including first displayable content; and
generating one or more auxiliary presentations for display on a respective one of the auxiliary display devices;
wherein the step of generating the first presentation includes associating the displayable content or part thereof with an auxiliary presentation which is thereafter displayable on one of the auxiliary display devices when said presentation content is displayed on the main display device.

11. A computer program stored on a computer-readable medium and Comprising computer-readable instructions for performing the steps of claim 1.

12. A computer presentation system comprising processing means arranged to operate under the control of the computer program as claimed in claim 11.

13. A presentation system comprising:
a control system;
a first display device connected to the control system; and
one or more further display devices connected to the control system;
wherein the control system is operable to (a) display first media content on the main display device, (b) associate an executable command with the first media content or part thereof, (c) in response to the first media content being displayed or a user action initiated during said display, causing execution of the executable command to cause output of second media content on one of the further display devices.
